(19) United States
(12) Patent Application Publication
(10) Pub. No.: US 2002/0043566 A1
(43) Pub. Date: Apr. 18, 2002

(54) Transaction card and method for reducing frauds

(76) Inventors: Alan Goodman, Santa Monica, CA (US); David Perron, Quebec (CA)

Correspondence Address: HESLIN ROTHENBERG FARLEY & MESITI PC, 5 COLUMBIA CIRCLE, ALBANY, NY, 12203, US

(21) Appl. No.: 09/905,641

(22) Filed: Jul. 13, 2001

Related U.S. Application Data
(60) Provisional application No. 60/218,153, filed on Jul. 14, 2000.

(51) Int. Cl. G06K 19/06

(52) U.S. Cl. 235/492; 705/65

(57) ABSTRACT

The transaction card and method are used for securing a transaction conducted by mean of a credit card, a debit card, a security card or any other card including information to be read by a magnetic card reader. The card is provided with a counter which increments by 1 or any other number each time the card is activated. This counter value is used with a key string in a cryptographic algorithm to produce a signature. The resulting data stream is then transmitted to a computer. The computer may be one of the servers of a bank, a credit card provider, a security department, etc. Once the data stream is received, the computer finds the record of the card or cardholder using the identification number or any other number, then determines with the signature if the transaction is legitimate or not. The counter value is also verified. Accordingly, if the counter value of the current transaction is below or equal to that of the last transaction, this means that someone is trying to use the same data stream twice or an expired data stream. Any suspect transaction would be denied and the standard protocol in case of the detection of a fraud initiated.

The present application claims the benefits of U.S. provisional patent application No. 60/218,153 filed Jul. 14, 2000 to Allan Goodman, which application is hereby incorporated by reference.

The present invention relates to a transaction card and a method for reducing frauds associated with conventional credit cards, debit cards, security cards or any other cards including information to be read by a magnetic card reader.

There are well over one billion magnetic stripe credit-card size cards using the about 25 million readers in the U.S. for a variety of purposes, such as credit or debit card transactions, computer access, identification, etc. Credit cards and debit cards are the most widely spread kinds of such cards.

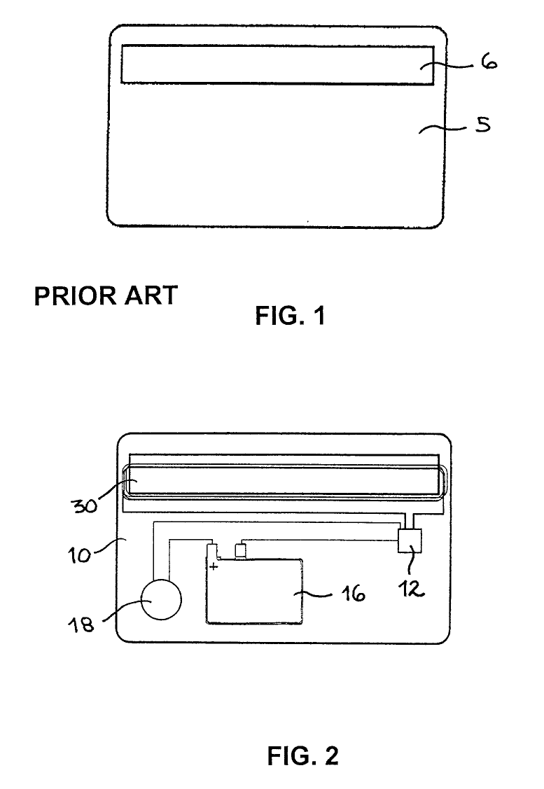

An example of a conventional credit or debit card is illustrated in prior art FIG. 1. The card 5 is made in accordance with the current standard, for instance ISO 7811. The card 5 is visually identified to its issuer and generally includes some visible characteristics which are more difficult to reproduce, such as holograms, watermarks, etc. The name of the cardholder, the number of the card and the expiration date are generally embossed on the card 5 and can be read from the front side. The card 5 further comprises a magnetic data carrying stripe 6, generally located at the back side, which can be read by a card reader at a point-of-sale (POS), an automated teller machine (ATM), a security access reader or by any other suitable means. In the case of credit cards, the magnetic stripe 6 generally includes information such as the card number and the expiration date. The magnetic stripe 6 may itself comprise one or more tracks.

Conventional credit cards and debit cards are easy targets for thieves and other criminals having the intention to obtain money or goods in a fraudulent manner. In the case of credit cards, anyone presenting a card is typically authenticated by simple possession of the card. Only in rare instances the cardholder is asked to provide a proof that he or she is indeed the legitimate user. Also only in rare instances is the card signature verified in a thorough and adequate manner. What results from the current situation is that a stolen credit card may easily be used by a criminal, generally until the time the theft of the card is reported to or detected by their proper authorities or if the credit limit is reached. Meanwhile, criminals may have had the time to illegally purchase valuable goods or services.

Another known problem is that the information appearing on a magnetic stripe of a card may be read using a portable or otherwise illicit magnetic stripe reader. This allows counterfeiters to create a fake card and use it in addition to the original card.

Debit cards are targeted by criminals as well, although a personal identification number (PIN) is used to make its use more secure. The problem is that many people do not properly hide the keys when they input in their PIN on a terminal so that a person standing nearby or even the cashier may learn it. Some criminals even record PINs using a hidden camera. If a criminal obtains both the information located on the magnetic stripe of a debit card and the NIP required to access a bank account, a counterfeited card may be created and used to illicitly draw amounts from the account of the person.

Known in the art are cards provided with a magnetic stripe where the information is only available temporarily. In such instances, the magnetic stripe is activated or otherwise enabled only when necessary. In some cases, a PIN needs to be entered on the card itself in order to unlock or activate the magnetic stripe, thereby improving security.

Also known in the art are cards where the magnetic stripe can emulate the information of a plurality of conventional cards. This allows someone to carry only a single card that can be used for a plurality of credit card accounts.

Examples of prior art devices can be found in U.S. Pat. Nos. 4,791,283, 4,868,376, 5,317,636, 5,336,871, 5,585,787, 5,594,227, 6,079,621, 6,089,451, 6,095,416, 6,098,881, 6,182,894, 6,188,309, 6,206,293, 6,240,515, 6,240,516 and 6,246,769, all of which are hereby incorporated by reference.

The present invention reduces the difficulties and disadvantages of prior art by providing a credit card, debit card, security card, etc, all of which are hereinafter referred to as a <<transaction card>> or simply as a <<card>>, in which the information on the magnetic stripe emulator is changing with every use. Preferably, this is done by providing the card with a counter which value increments by 1 or any other number each time the card is activated.

Upon activation of the card, the card number (or any other identification number) and a counter value are obtained from the memory of the card to form portions of a data stream that is to be transferred to the reading head of the card reader. The data stream also includes a signature, which is generated using the counter value, a key string and a corresponding cryptographic algorithm. The key string is pre-recorded in the memory and is only known by the card and the computer to which the data stream is ultimately transmitted. The computer may be one of the servers of a bank, a credit card provider, a security department, etc. Each key string is preferably unique to each card being produced.

Once the data stream is received, the computer finds the record of the card or cardholder using the identification number or any other number, then determines with the signature if the transaction is legitimate or not. The counter value is also verified. Accordingly, if the counter value of the current transaction is below or equal to that of the last transaction, this means that someone is trying to use the same data stream twice or an expired data stream. Any suspect transaction would be denied and the standard protocol in case of the detection of a fraud initiated.

These and other aspects and advantages of the present invention are described in or apparent from the following detailed description of preferred and possible embodiments made in conjunction with the accompanying figures, in which:

FIG. 1 is a schematic view of the back side of a conventional transaction card as found in prior art.

FIG. 2 is a schematic view of the inside of a transaction card, made in accordance with a possible embodiment.

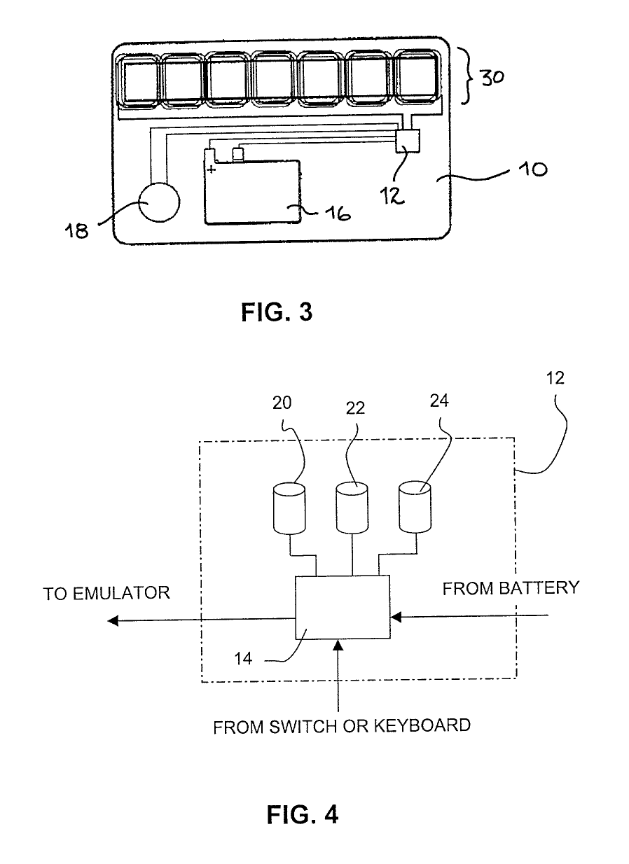

FIG. 3 is a schematic view similar to FIG. 2, illustrating an alternative embodiment.

FIG. 4 is a block diagram of the components of the chip inside the card.

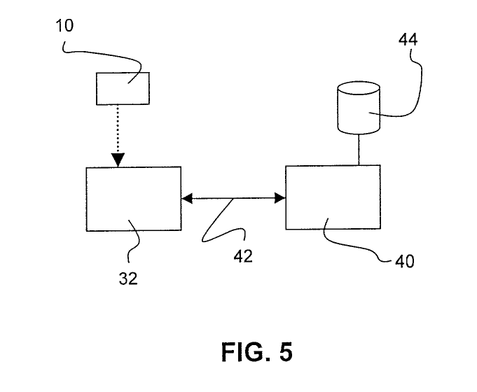

FIG. 5 is a block diagram of a transaction system using the method in accordance with the present invention.

Referring first to FIG. 2, there is shown is a schematic view of internal components of a transaction card 10 made in accordance with a possible embodiment of the present invention. FIG. 3 shows an alternative embodiment. This card 10 is preferably built to be conformed with the ISO 7811 standard or any subsequent version or applicable standard. It can also be conformed with the ISO 7816 standard which relates to <<smart cards>>. Thus, the card 10 is preferably designed to use the existing reader infrastructure or network. Of course, it is also possible to design a card which is for use only in a specific application and would not be compatible with conventional readers.

The card 10 is manufactured in accordance with any known techniques in the art, such as by injection, machining, lamination, molding, or even a combination of them. It preferably features a laminated construction, which essentially comprises a core layer sandwiched between two outer layers. The components necessary to make the card 10 function are embedded or otherwise made inaccessible therein. To that respect, the card 10 is similar a <<smart card>> as it comprises a chip 12 bearing most required components to make the card function, including a microcontroller (CPU) 14. The exact kind of microcontroller 14 depends on the available models when the card is designed and the design requirements. Two possible candidates are microcontrollers MSP430P112 and MSP430C112 from TEXAS INSTRUMENTS, depending if programming is required not. The card 10 is powered by a battery 16 having enough energy to last for the life thereof. It should be noted that the design of the battery 16 may be different from that is shown in FIGS. 2 and 3, for example to allow letters, numbers and symbols to be embossed, if required, as on most conventional credit or debit cards. The layout of the other components on the card may also be different.

Preferably, the card 10 is temporarily activated, i.e. switched on, using a pressure switch 18 comprising a flexible membrane closing a circuit when a finger pressure is applied. This sends an activation signal to the microcontroller 14. Rather than simply switching on the card 10, it is also possible to provide a keypad for a PIN or any other additional security feature, including for instance a biometrics sensor. Other kinds of switches may be used as well, for instance a piezoelectric sensor.

The chip 12 provided on the card 10 preferably comprises a first memory 20, such as a programmable non-volatile memory (for example EPROM, EEPROM or FLASH), in which a program is pre-recorded using programming leadouts (not shown) during the manufacturing process. Alternatively, the program can be pre-recorded in a ROM memory. It also comprises a second memory 22 in which invariable information unique to each card is pre-recorded during the manufacturing process, more particularly during the customization of the card 10. These invariable information include an encryption key string, preferably unique to each card, and other information such as the card number, the expiration date, the serial number, etc. A third memory 24 is used for recording counter values, as explained further below.

The second 22 and third memory 24 may be volatile memories (RAM), or non-volatile memories (for example EPROM, EEPROM or FLASH). Further, the first memory 20, second memory 22 and/or third memory 24 may be different addresses in a same memory module located in the microcontroller 14 itself.

As an additional security feature, the content of the second memory 22 may be erased if the battery 16 is disconnected, which is likely to happen when someone is attempting to open or tamper with a card. The exact design of the memories and the nature thereof is something well-known in the art and does not need to be further detailed herein.

The microcontroller 14 increments the counter value stored in the third memory 24 by 1 or any other number each time the card is activated throughout the life of the card. The update of the counter is made either before or after generating the data stream as explained hereinafter.

The card 10 includes a magnetic stripe emulator 30 that is used to transfer information to a card reader using magnetic fields having a strength and a transfer rate similar to that of a standard, permanent magnetic stripe being moved through the slot of the reader. It is to be noted that with most emulators, the magnetic stripe of a conventional card is not physically replicated but it is rather the information on it that is simulated to allow the information to be read by a conventional card reader. Further, the card 10 may still be provided with a partial conventional magnetic stripe. In that case, the emulator 30 would only be use to replicate the information on one or some of the tracks that form a conventional magnetic stripe, such as the magnetic stripe 6 shown in FIG. 1.

The emulator 30 may be built in accordance with one of the known embodiments, depending on the exact application. One possible embodiment is to provide one or more coils, located within the card itself, which are used to generate a magnetic field. The microcontroller 14 commands the changes in the tension at the terminals of the coil or coils. The fluctuation of the tension will generate a field which polarity changes, positive or negative. The coils can be made of small copper wires or any other kind of conductor. These small wires can be laid directly on one of the layers of the card 10 or on a substrate that will be embedded in the card 10 during its manufacturing process.

As aforesaid, it can be desirable for security reasons to switch on the card 10 using a keyboard and an associated PIN. Therefore, the card 10 is only fully activated by the microcontroller 14 when it determines that a keyed number matches the or one of the PIN pre-recorded a corresponding memory, for instance the second memory 22. Further, when a card includes a PIN, a maximum number of invalid attempts may be programmed. If this maximum number is reached, for example three invalid attempts, the card could be deactivated for a period of time or even permanently. Once a valid PIN is entered, or if the pressure switch 18 is pressed, the card 10 is preferably activated only for a limited time, for example three minutes or less. This allows to significantly increase the life of the battery 16, thus the card itself.

In the preferred embodiment, a transaction is made by inserting the card 10 in the slot of the reader so that the magnetic stripe emulator 30 be in registry with the reader head (not shown). When the cardholder or cashier activates the pressure switch 18, the microcontroller 14 generates a data stream.

Upon activation of the card 10, the card number or another identification number is obtained from the second memory 22, and a counter value is obtained from the third memory 24 of the card to form portions of a data stream that is to be transferred to the reading head of the card reader. The data stream also includes a signature, which is generated using at least the encryption key string obtained from the second memory 22 and the counter value. The key string and the counter value are then inserted in a cryptographic algorithm stored in the first memory 20 and executed by the microcontroller 14. The key string is only known by the card 10 and a computer to which the data stream is ultimately transmitted. Further, it is possible to use other additional information in the cryptographic algorithm, for instance a PIN only known by the computer, thus improving security.

Once the data stream is generated, or even simultaneously, the data stream is sent to the magnetic stripe emulator 30, where it is transferred to the reading head of the card reader. The card 10 may be emitting the data stream a number of times to make sure that it is properly received by the card reader or the computer. The reader will transmit the data stream and other information to a computer for processing, usually a remote computer, using a corresponding authentication and/or decryption software at that end and carrying out the conventional database lookup for transaction cards. The other information are, for example, the vendor ID and the amount of the transaction in the case of a credit card transaction. It is to be noted that the term <<computer>> means any computer or cluster of computers, as well as any similar device, carrying out the tasks of authentication and the ones related to the transaction itself.

Preferably, once the data stream is received by the computer, it finds the record of the card or cardholder using the card number or any other information supplied, then attempts to find a match between a second signature generated using the counter value contained in the data stream, and the key string obtained from the record. Also, the computer verifies the counter number of the current transaction is below or equal to that of the last transaction. If this is the case, it means that someone is trying to use the same data stream twice, for example someone recorded the data stream before a genuine transaction was made or that the transmission was recorded somewhere between the card reader and the computer. Accordingly, the transaction or access would be rejected and the standard protocol in case of the detection of a fraud initiated. Conversely, if both the first signature and counter value are valid, the transaction is completed normally. All this processing usually takes only a few seconds.

Alternatively, the data stream may not contain the counter value. The computer then tries to find a match between a second signature generated using the next valid counter number, which number is obtained from the counter number of the last transaction. If that fails, it tries a predetermined range of other subsequent values. If not match is found within the given range, then the transaction is rejected. Conversely, if a match is found, the transaction is authenticated and the counter value or the next valid counter number is updated in the record of the card or cardholder.

Another possible embodiment is that once the data stream is received by the computer, it finds the record of the card or cardholder using the card number or any other information supplied, then decrypts the signature using the counter value contained in the data stream and a decryption key string obtained from the record. Depending on the kind of algorithm used, the encryption key string and the decryption key string may be identical or complementary. If decryption fails, this means that the encryption key string and/or the algorithm used is wrong, thus that there is probably an attempt to make a fraudulent use of the transaction card. This embodiment may also be done if the counter number is not supplied in the data stream. It then works in a similar fashion than that explained for the other embodiment.

FIG. 5 illustrates the process in a transaction involving a credit card. In this case, the card 10 is inserted inside a reader 32, usually at the POS. The reading head receives the data stream from the card 10 and transmit it to the computer 40 of the credit card center using an appropriate link 42, for example a telephone line. The computer 40 decrypts the signature using the counter value and the decryption key string from the corresponding record for the card or cardholder in a storage memory 44, which storage memory 44 can be within the computer 40 or at an offsite location.

If everything is in good order, the transaction is completed in a traditional fashion, such as sending back to the reader an authorization number, applying the charge to the account of the client as well as an amount to be transmitted to the merchant. In the case of a security access, completing the transaction would mean granting the access, for example unlocking a door. The records of the card or cardholder in the storage memory 44 will also be updated to take into account the current counter value. The updated counter value can be the actual number transmitted by the card 10 or the next valid number.

It should be noted that the card 10 counts each time it is activated. Consequently, since the card 10 may be activated without being inserted in a reader or for the purpose of a transaction, a valid counter value may be almost any higher value of the counter compared to that of the last transaction. Also possible is the fact that the counter value be decreasing instead of increasing after each use. It is to be understood that the card 10 will work exactly the same way but in a reverse fashion. This may be useful for limiting a card to a maximum number of activation. However, the same could be realized with increasing counter values if a limit value is programmed.

As can be appreciated, the presence of an encrypted signature in the data stream transmitted to the computer 40 prevents a data stream from being easily replicated unless it is recorded. However, in that case, the computer keeps track and updates the counter value in the database to reject any data stream with a counter value being equal or lower than that of the last transaction. At worst, someone with an illicit magnetic stripe reader can get a data stream and use it in a counterfeited card if the legitimate cardholder does not complete a transaction with the computer before the counterfeited card is used. However, the counterfeited card would only be valid once, all subsequent attempts to use the same data stream being denied and reported to authorities. Adding a PIN to unlock the card also increases to level of security and prevent someone from using a stolen or lost card. Therefore, the above-described transaction card and method decrease significantly the risks of frauds associated with conventional transaction cards.

Although preferred embodiment of the invention have been described in detail herein and illustrated in the accompanying figures, it is to be understood that the invention is not limited to these precise embodiments and that various changes and modifications may be effected therein without departing from the scope or spirit of the present invention.

What is claimed is:

1. A transaction card for use with a magnetic stripe reading head of a card reader, the card containing a key string and a cryptographic algorithm stored in a memory, the card comprising:
first means for selectively activating the card;
second means for obtaining a value indicative of the number of times the card is activated;
third means for generating a signature using the key string, the value indicative of the number of times the card is activated and the cryptographic algorithm;
fourth means for generating a data stream comprising at least an identification number and the signature; and
a magnetic stripe emulator in communication with the third means for transferring the data stream to the magnetic stripe reading head.

2. A transaction card in accordance with claim 1, wherein the data stream comprises the value indicative of the number of times the card is activated.

3. A transaction card in accordance with claim 1, wherein the first means comprises a switch.

4. A transaction card in accordance with claim 3, wherein the switch is a pressure switch to be activated using finger pressure.

5. A transaction card in accordance with claim 1, wherein the first means comprise a keyboard, the card further comprising means for comparing a PIN recorded in the memory of the card with a keyed number from the keyboard, the card being activated for a limited time if both numbers are matching.

6. A transaction card for use with a magnetic stripe reading head of a card reader, the card having a memory in which information is stored, the card comprising:
a battery;
a switch;
a microcontroller powered by the battery and activated upon receiving an activation signal from the switch, the microcontroller having encoded therein a computer program carrying out the tasks of:
obtaining a value indicative of the number of times the card is activated;
reading a key string from the memory of the card;
reading an identification number from the memory of the card;
generating a signature using a cryptographic algorithm in which is inputted at least the key string and the value indicative of the number of times the card is activated; and
generating a data stream comprising at least the identification number and the signature; and
a magnetic stripe emulator in communication with the microcontroller to transfer the data stream to the magnetic stripe reading head.

7. A transaction card in accordance with claim 6, wherein the data stream further comprises the value indicative of the number of times the card is activated.

8. A transaction card in accordance with claim 6, wherein the identification number comprises the serial number of the card.

9. A transaction card in accordance with claim 6, wherein the switch is a pressure switch to be activated using finger pressure.

10. A transaction card in accordance with claim 6, wherein the switch comprises a keyboard, the microcontroller further carrying out the tasks of:
receiving a keyed number from the keyboard;
comparing the keyed number with a pre-recorded PIN read from a corresponding memory; and
activating the card for a limited time if both numbers are matching.

11. A method of reducing frauds using a transaction card containing information to be read by a magnetic stripe reading head of a card reader in communication with a computer, the method comprising:
activating the card;
obtaining a value indicative of the number of times the card is activated;
reading a key string and an identification number stored on the card;
generating a first signature using a cryptographic algorithm stored on the card and in which is inputted at least the key string and the value indicative of the number of times the card is activated;
generating a data stream containing at least the identification number and the first signature;
transferring the data stream to the magnetic stripe reading head;
transmitting the data stream to the computer; and
upon receipt of the data stream by the computer:
a) finding a record corresponding to the card using the identification number;
b) attempting to find a match between the first signature and a second signature generated using the key string found in the record and one among a given number of sequential counter values starting with a next valid value obtained from the counter value of the last transaction, as indicated in the record;
c) determining that the transaction when a match if found between the first and second signature.

12. A method in accordance with claim 11, further comprising:
d) upon determining that the transaction is valid, recording one among the counter value used for generating the second signature matching the first signature or a next corresponding valid counter value.

13. A method in accordance with claim 11, further comprising:
receiving a PIN keyed at a keyboard provided on the card;
including the keyed PIN in the algorithm when generating the first signature; and
upon receipt of the data stream by the computer, including the PIN as found in the record for generating the second signature.

14. A method in accordance with claim 11, wherein the act of activating the card comprises comparing a pre-recorded PIN with a keyed number from a keyboard provided on the card, the card being activated for a limited time if both numbers are matching.

15. A method of reducing frauds using a transaction card containing information to be read by a magnetic stripe reading head of a card reader in communication with a computer, the method comprising:
activating the card;
obtaining a value indicative of the number of times the card is activated;
reading a key string and an identification number stored on the card;
generating a signature using a cryptographic algorithm stored on the card and in which is inputted at least the key string and the value indicative of the number of times the card is activated;
generating a data stream containing at least the identification number, the value indicative of the number of times the card is activated, and the signature;
transferring the data stream to the magnetic stripe reading head;
transmitting the data stream to the computer; and
upon receipt of the data stream by the computer:
a) finding a record corresponding to the card using the identification number;
b) determining if there is a match between the first signature and a second signature generated using the value indicative of the number of times the card is activated, as found in the data stream, and the key string obtained from the record;
c) determining whether the value indicative of the number of times the card is activated is higher than that of a last transaction with the card; and
d) determining that the transaction is valid when both b) and c) are answered in the affirmative.

16. A method in accordance with claim 15, further comprising:
receiving a PIN keyed at a keyboard provided on the card;
including the keyed PIN in the algorithm when generating the first signature; and
upon receipt of the data stream by the computer, including the PIN as found in the record for generating the second signature.

17. A method in accordance with claim 15, wherein the act of activating the card comprises comparing a pre-recorded PIN with a keyed number from a keyboard provided on the card, the card being activated for a limited time if both numbers are matching.

18. A method of reducing frauds using a transaction card containing information to be read by a magnetic stripe reading head of a card reader in communication with a computer, the method comprising:
activating the card;
obtaining a value indicative of the number of times the card is activated;
reading an encrypting key string and an identification number stored on the card;
generating a signature using a cryptographic algorithm stored on the card and in which is inputted at least the key string and the value indicative of the number of times the card is activated;
generating a data stream containing at least the identification number and the signature;
transferring the data stream to the magnetic stripe reading head;
transmitting the data stream to the computer; and
upon receipt of the data stream by the computer:
a) finding a record corresponding to the card using the identification number;
b) attempting to decrypt the signature using a decryption key string found in the record and one among a given number of sequential counter values starting with a next valid value obtained from the counter value of the last transaction, as indicated in the record;
c) determining whether the decryption is successful or not;
d) determining that the transaction is valid when c) is answered in the affirmative.

19. A method in accordance with claim 18, further comprising:
e) upon determining that the transaction is valid, recording one among the counter value used for decrypting the signature or a next corresponding valid counter value.

20. A method in accordance with claim 18, further comprising:
receiving a PIN keyed at a keyboard provided on the card;
including the keyed PIN in the algorithm when generating the signature; and
upon receipt of the data stream by the computer, including the PIN as found in the record for decrypting the signature.

21. A method in accordance with claim 18, wherein the encryption key string and the decryption key string are identical.

22. A method in accordance with claim 18, wherein the act of activating the card comprises comparing a pre-recorded PIN with a keyed number from a keyboard provided on the card, the card being activated for a limited time if both numbers are matching.

23. A method of reducing frauds using a transaction card containing information to be read by a magnetic stripe reading head of a card reader in communication with a computer, the method comprising:
activating the card;
obtaining a value indicative of the number of times the card is activated;
reading an encrypting key string and an identification number stored on the card;
generating a signature using a cryptographic algorithm stored on the card and in which is inputted at least the key string and the value indicative of the number of times the card is activated;
generating a data stream containing at least the identification number, the value indicative of the number of times the card is activated, and the signature;
transferring the data stream to the magnetic stripe reading head;
transmitting the data stream to the computer; and
upon receipt of the data stream by the computer:
a) finding a record corresponding to the card using the identification number;
b) decrypting the signature from the data stream using the value indicative of the number of times the card is activated, as found in the data stream, and a decryption key string obtained from the record;
c) determining whether the decryption is successful or not;
d) determining whether the value indicative of the number of times the card is activated is higher than that of a last transaction with the card; and
e) determining that the transaction is valid when both c) and d) are answered in the affirmative.

24. A method in accordance with claim 23, wherein the encryption key string and the decryption key string are identical.

25. A method in accordance with claim 23, further comprising:
receiving a PIN keyed at a keyboard provided on the card;
including the keyed PIN in the algorithm when generating the signature; and
upon receipt of the data stream by the computer, including the PIN as found in the record for decrypting the signature.

26. A method in accordance with claim 23, wherein the act of activating the card comprises comparing a pre-recorded PIN with a keyed number from a keyboard provided on the card, the card being activated for a limited time if both numbers are matching.
